(19) United States
(12) Patent Application Publication
(10) Pub. No.: US 2012/0027237 A1
(43) Pub. Date: Feb. 2, 2012

(54) PROTECTIVE SLEEVE HAVING A BUILT-IN SOUND-AMPLIFYING CHANNEL

(76) Inventor: Chin-Sheng LIN, New Taipei City (TW)

(21) Appl. No.: 13/105,067

(22) Filed: May 11, 2011

(30) Foreign Application Priority Data
Jul. 28, 2010 (TW) 099214340

(51) Int. Cl. H04R 1/02

(52) U.S. Cl. 381/340; 381/339

(57) ABSTRACT

A protective sleeve having a built-in sound-amplifying channel is configured to cover a portable electronic product having an audio port. The protective sleeve includes an accommodating portion and a sound-amplifying channel. The accommodating portion is provided in the protective sleeve for allowing the portable electronic product to be accommodated therein. The sound-amplifying channel is formed in the protective sleeve. One end of the sound-amplifying channel is connected to the audio port, and the other end thereof protrudes from the protective sleeve to form a sound-amplifying section. The sound of the portable electronic product is emitted from the audio port and amplified through the sound-amplifying channel and the sound-amplifying section. Thus, an external loud speaker is unnecessary, and the protective sleeve itself can generate a good sound-amplifying effect, thereby increasing the functionality and practicability thereof greatly.

### BACKGROUND OF THE INVENTION

1. Field of the Invention

The present invention relates to a protective sleeve of a portable electronic product, and in particular to a protective sleeve having a built-in sound-amplifying channel.

2. Description of Prior Art

With the advancement of science and technology, many kinds of portable electronic products are proposed and widely used in our daily life, such as mobile phones, digital cameras, MP3 players or the like. In order to protect these portable electronic products from suffering scraps or wears, various protective sleeves are designed accordingly. Such protective sleeves are made of plastic, rubber, silicon, synthetic leather or natural leather to cover outer surfaces of the portable electronic product for protection.

When a user intends to listen to the music emitted from an audio port of the portable electronic device, the user has to insert an earphone plug into the audio port and then wears the earphone to thereby hear the music. Alternatively, the user utilizes a loud speaker built in the portable electronic product to play the music via the audio port. However, the sound-amplifying effect of this built-in loud speaker of the portable electronic device is insufficient. Thus, most people like to use an external loud speaker to generate a better loud-amplifying effect, which consumes more electricity and makes the user feel inconvenient to carry such an external loud speaker.

Although the above conventional protective sleeve protects the outer surfaces of the portable electronic product, it does not have a sound-amplifying effect. If the protective sleeve itself has a sound-amplifying effect, the user needs not to carry an external loud speaker additionally. The protective sleeve itself generates a good sound-amplifying effect, which is convenient and practical. Thus, it is an important issue for the present inventor to solve the above-mentioned problems.

### SUMMARY OF THE INVENTION

The present invention is to provide a protective sleeve having a built-in sound-amplifying channel, which is provided with an internal sound-amplifying channel to generate a sufficient sound-amplifying effect.

The present invention is to provide a protective sleeve having a built-in sound-amplifying channel, which is configured to cover a portable electronic product having an audio port, the protective sleeve including:

an accommodating portion provided in the protective sleeve for allowing the portable electronic product to be accommodated therein; and

a sound-amplifying channel formed in the protective sleeve, one end of the sound-amplifying channel being connected to the audio port, and the other end thereof protruding from the protective sleeve to form a sound-amplifying section,

wherein a sound of the portable electronic product is emitted from the audio port and amplified through the sound-amplifying channel and the sound-amplifying section.

In comparison with prior art, the present invention has the following advantageous features.

Since the protective sleeve of the present invention is provided therein with a sound-amplifying channel, the sound of the portable electronic product is emitted from the audio port and amplified through the sound-amplifying channel and the sound-amplifying section. Thus, an external loud speaker is unnecessary, and the protective sleeve itself can generate a sufficient sound-amplifying effect. Therefore, the functionality and practicability of the protective sleeve of the present invention is increased greatly.

### BRIEF DESCRIPTION OF DRAWING

FIG. 1 is a perspective view showing a first embodiment of the present invention;

FIG. 2 is a cross-sectional view taken along the line 2-2 in FIG. 1;

FIG. 3 is a cross-sectional view showing that the protective sleeve of the present invention covers a portable electronic product;

FIG. 4 is a schematic view showing the sound-amplifying channel according to the first embodiment of the present invention;

FIG. 5 is another schematic view showing the sound-amplifying channel according to the first embodiment of the present invention;

FIG. 6 is a perspective view showing a second embodiment of the present invention; and

FIG. 7 is a cross-sectional view taken along the line 7-7 in FIG. 6.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

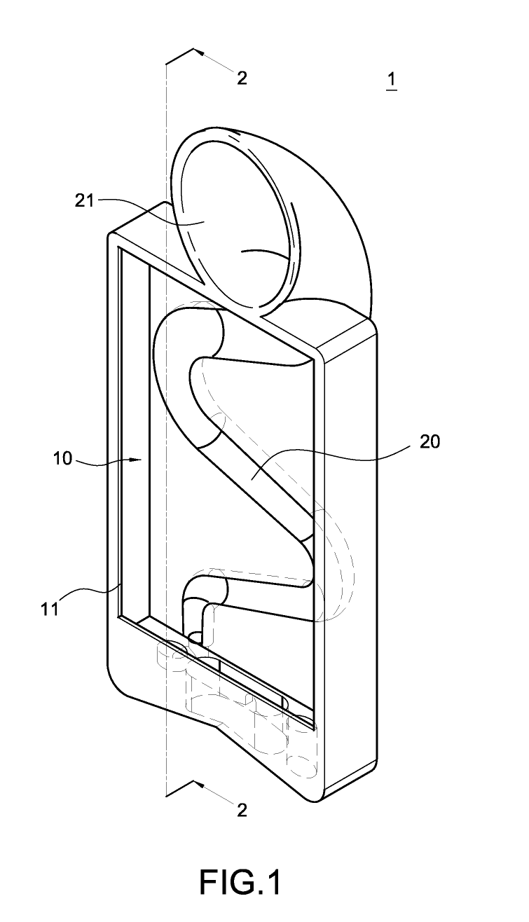

Please refer to FIGS. 1 to 3. The present invention provides a protective sleeve 1 having a built-in sound-amplifying channel, which is configured to cover a portable electronic product 100 shown in FIG. 1 and having an audio port 110. In the present embodiment, the audio port 110 is located in the bottom of the portable electronic product 100. Of course, the audio port 110 may be provided in the portable electronic product 100 at other locations based on practical demands.

The protective sleeve 1 includes an accommodating portion 10 and a sound-amplifying channel 20. In the present embodiment, the portable electronic product 100 is formed into a rectangular shape, which is the most common shape. may be made of plastic rubber, silicon or other materials having suitable flexibility and stretchability.

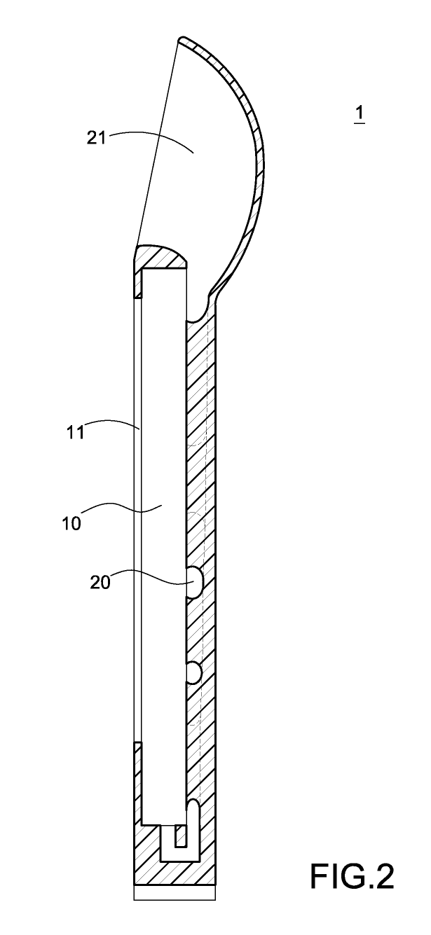

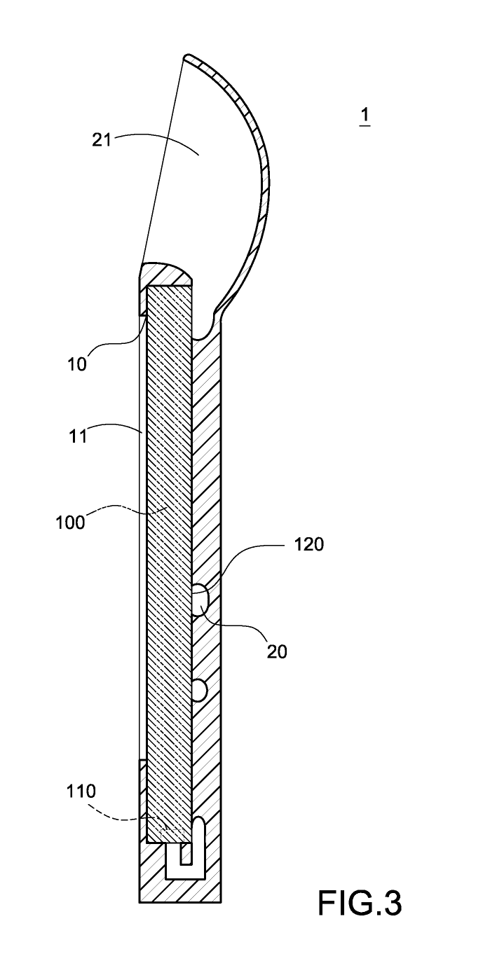

The accommodating portion 10 is provided in the protective sleeve 1 for allowing the portable electronic product 100 to be accommodated therein. The accommodating portion 10 is provided in the front surface of the protective sleeve 1, so that the user can put the protective sleeve 1 on the portable electronic product 100 easily. It can be seen from FIG. 2 that, in the front surface of the protective sleeve 1, the accommodating portion 10 has an accommodating opening 11. The user can put the upper edge of the portable electronic product 100 into the inner upper edge of the accommodating opening 11. Then, by means of the flexibility and stretchability of the protective sleeve 1, the user stretches the lower edge of the accommodating opening 11, so that the portable electronic product 100 can be completely disposed into the accommodating opening 100 as shown in FIG. 3. In this way, the protective sleeve 1 can cover the portable electronic product 100 completely.

The sound-amplifying channel 20 is formed in the protective sleeve 1. One end of the sound-amplifying channel 20 is connected to the audio port 110, and the other end thereof protrudes from the protective sleeve 1 to form a sound-amplifying section 21. In the first embodiment of the present invention, the sound-amplifying channel 20 is formed into an open channel. Although the sound-amplifying channel 20 is an open channel, when the portable electronic product 100 is disposed in the accommodating portion 10 of the protective sleeve 1, one outer surface of the portable electronic product 100 covers the open sound-amplifying channel 20 to form a substantially enclosed channel. Further, the sound-amplifying channel 20 has a zigzag shape to extend its length. By means of this sufficiently long channel 20, the difference between the diameters of both ends of the sound-amplifying channel 20 can be increased gradually. It can be seen from FIG. 1 that, the sound-amplifying section 21 is shaped as a horn extending from the rear surface of the protective sleeve 1 to be located on the upper edge of the protective sleeve 1. In this way, the sound-amplifying channel 20 can be integrally formed with the protective sleeve 1. The sound of the portable electronic product 100 is emitted from the audio port 110 and amplified through the sound-amplifying channel 20 and the sound-amplifying section 21, so that the protective sleeve 1 of the present invention can generate a sufficient sound-amplifying effect.

As shown in FIG. 1, the lower portion of the protective sleeve 1 may be provided with different through-holes (indicated by dotted lines) to correspond to the connecting ports of the portable electronic product 100 for allowing a power line, a USB transmission line and other plugs to be inserted therein.

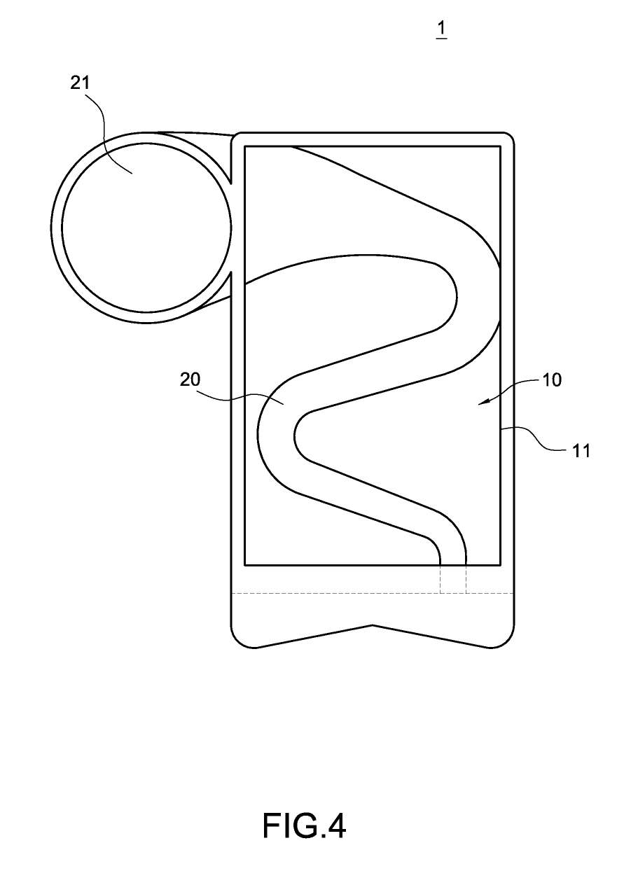

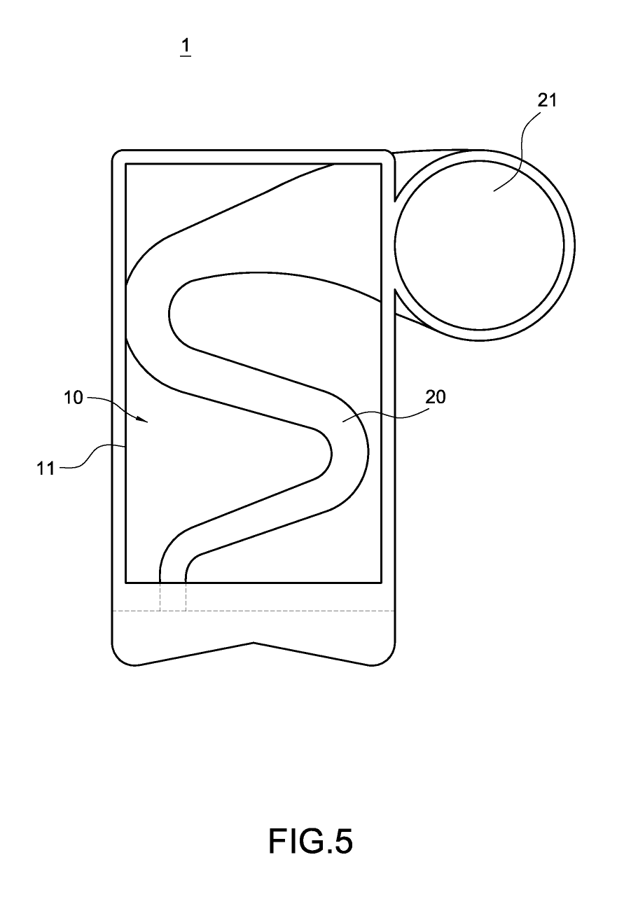

Please refer to FIGS. 4 and 5. The sound-amplifying channel 20 can be designed in different ways based on the locations of the audio ports 110 of the respective electronic products 100. In FIG. 4, the audio port 110 is located in the lower right corner of the portable electronic product 100, so that the sound-amplifying channel 20 zigzags from the lower right corner to the upper left corner of the protective sleeve 1 and finally forms a sound-amplifying section 21 outside the upper left corner of the protective sleeve 1. In FIG. 5, the audio port 110 is located in the lower left corner of the portable electronic product 100, so that the sound-amplifying channel 20 zigzags from the lower left corner to the upper right corner of the protective sleeve 1 and finally forms a sound-amplifying section 21 outside the upper right corner of the protective sleeve 1.

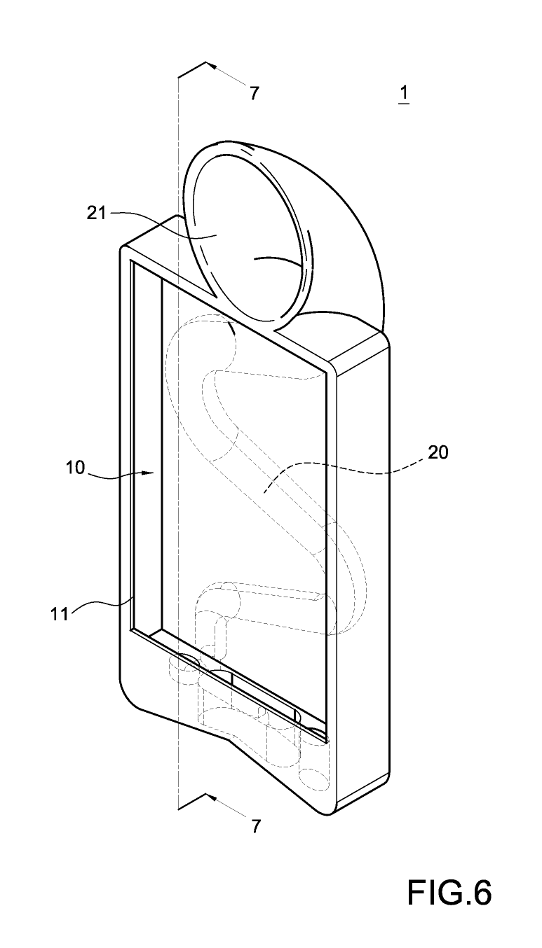

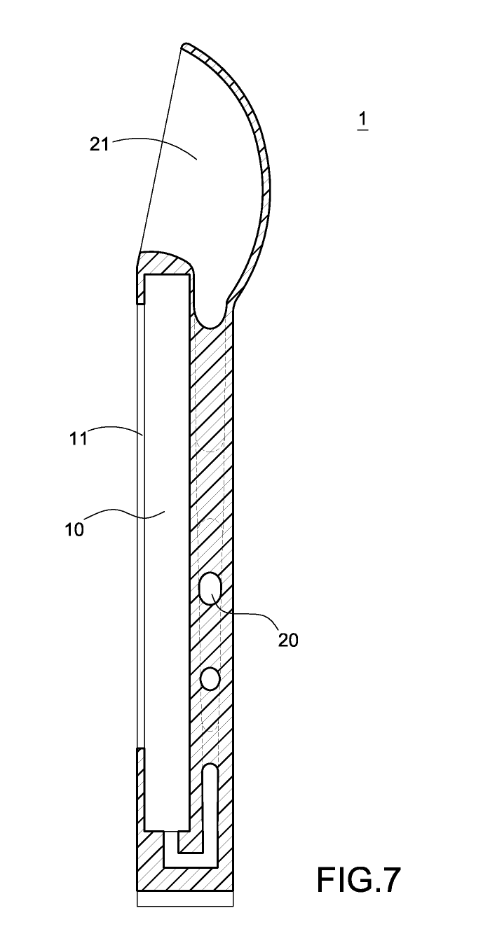

Please refer to FIGS. 6 and 7, which show the second embodiment of the present invention. The difference between the second embodiment and the first embodiment lies in that: the sound-amplifying channel 20 of the first embodiment is in communication with the accommodating portion 10 and formed as an open channel, whereas the sound-amplifying channel 20 of the second embodiment is separated from the accommodating portion 10 and completely hidden in the protective sleeve 1. More specifically, as shown in FIG. 7, the thickness of the protective sleeve 1 in the second embodiment is larger than that in the first embodiment. Although the accommodating portion 10 is provided on the front surface of the protective sleeve 1, the sound-amplifying channel 20 may be provided within the protective sleeve 1 to be separated from the accommodating portion 10. Like the first embodiment, one end of the sound-amplifying channel 20 is connected to the audio port 110 of the portable electronic product 100, and the other end thereof protrudes from the protective sleeve 1 to form a sound-amplifying section 21. The sound-amplifying section 21 is also shaped as a horn.

In comparison with prior art, the present invention has the following advantageous features.

Since the protective sleeve 1 of the present invention is provided therein with a sound-amplifying channel 20, the sound of the portable electronic product 100 is emitted from the audio port 110 and amplified through the sound-amplifying channel 20 and the sound-amplifying section 21. Thus, an external loud speaker is unnecessary, and the protective sleeve 1 itself can generate a sufficient sound-amplifying effect. Therefore, the functionality and practicability of the protective sleeve 1 of the present invention is increased greatly.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A protective sleeve having a built-in sound-amplifying channel, configured to cover a portable electronic product having an audio port, the protective sleeve including:
an accommodating portion provided in the protective sleeve for allowing the portable electronic product to be accommodated therein; and
a sound-amplifying channel formed in the protective sleeve, one end of the sound-amplifying channel being connected to the audio port, and the other end thereof protruding from the protective sleeve to form a sound-amplifying section,
wherein a sound of the portable electronic product is emitted from the audio port and amplified through the sound-amplifying channel and the sound-amplifying section.

2. The protective sleeve having a built-in sound-amplifying channel according to claim 1, wherein the sound-amplifying channel is in communication with the accommodating portion, the sound-amplifying channel is shaped as an open channel and brought into tight contact with an outer surface of the portable electronic product.

3. The protective sleeve having a built-in sound-amplifying channel according to claim 2, wherein the accommodating portion is provided with an accommodating opening, the portable electronic product is disposed into the accommodating portion of the protective sleeve via the accommodating opening.

4. The protective sleeve having a built-in sound-amplifying channel according to claim 2, wherein the profile of the accommodating portion is made to correspond to the profile of the portable electronic product, the protective sleeve is made of a material selected from a group including plastic, rubber and silicon.

5. The protective sleeve having a built-in sound-amplifying channel according to claim 2, wherein the sound-amplifying channel is shaped as a zigzag channel.

6. The protective sleeve having a built-in sound-amplifying channel according to claim 2, wherein the sound-amplifying section is shaped as a horn extending outside the protective sleeve.

7. The protective sleeve having a built-in sound-amplifying channel according to claim 1, wherein the sound-amplifying channel is separated from the accommodating portion.

8. The protective sleeve having a built-in sound-amplifying channel according to claim 7, wherein the accommodating portion is provided with an accommodating opening, the portable electronic product is disposed into the accommodating portion of the protective sleeve via the accommodating opening.

9. The protective sleeve having a built-in sound-amplifying channel according to claim 7, wherein the profile of the accommodating portion is made to correspond to the profile of the portable electronic product, the protective sleeve is made of a material selected from a group including plastic, rubber and silicon.

10. The protective sleeve having a built-in sound-amplifying channel according to claim 7, wherein the sound-amplifying channel is shaped as a zigzag channel.

11. The protective sleeve having a built-in sound-amplifying channel according to claim 7, wherein the sound-amplifying section is shaped as a horn extending outside the protective sleeve.
